(19) United States
(12) Patent Application Publication
(10) Pub. No.: US 2026/0060202 A1
(43) Pub. Date: Mar. 5, 2026

(54) Pet Screen

(71) Applicant: Ruizhu Tian, Dongguan (CN)

(72) Inventor: Ruizhu Tian, Dongguan (CN)

(21) Appl. No.: 18/818,531

(22) Filed: Aug. 28, 2024

(51) Int. Cl. A01K 1/02; B60N 2/90

(52) U.S. Cl. CPC A01K 1/0272; B60N 2/91

(57) ABSTRACT

Disclosed is a pet screen, including a main plate assembly and two connecting members for fixedly connecting headrests of car seats. The main plate assembly includes a main block and two side blocks, where the two side blocks are hinged with left and right sides of the main block, and the two side blocks are arranged to be foldable or expandable relative to the main block. The two connecting members are arranged on the two side blocks respectively. The main plate assembly can be secured on the headrests of car seats through the connecting members, which separates the trunk space from the rear space, and efficiently delimits a pet activity area, thereby ensuring driving safety due to no pet disturbance to the driver, and enhancing the utilization of interior space.

### TECHNICAL FIELD

The present disclosure relates to the technical field of pet supplies, and particularly relates to a pet screen.

### BACKGROUND

When going out by car, many pet owners hope to carry their own pets. A pet is usually placed in rear space or trunk space of a car. When the pet is placed in the rear space, the pet can easily break into a driving cab, which will distract a driver due to disturbance by the pet in the driving process, thereby affecting driving safety. Similarly, when the pet is placed in the trunk space, the pet can easily climb into the rear space and even the driving cab because tops of rear seats in the car are not separated from the trunk, which will distract the driver and affect driving safety. Therefore, it is necessary to provide a technical solution to solve the above problems.

### SUMMARY

In view of this, aiming at the deficiencies in the prior art, a main objective of the present disclosure is to provide a pet screen capable of effectively solving the problem of the prior art that driving safety is affected because a pet moving in a car easily distracts a driver.

To achieve the above objective, the present disclosure adopts the following technical solution:

A pet screen, including a main plate assembly and two connecting members for fixedly connecting headrests of car seats, where the main plate assembly includes a main block and two side blocks, where the two side blocks are hinged with left and right sides of the main block, and the two side blocks are arranged to be foldable or expandable relative to the main block; and the two connecting members are arranged on the two side blocks respectively.

Preferably, extension plates are mounted on the two side blocks through fastening assemblies respectively.

Preferably, each of the fastening assemblies includes a first side cover, a second side cover and a nut element, a screw rod is arranged on the first side cover, and a through hole is formed in the second side cover; and the side block and the extension plate are clamped between the first side cover and the second side cover, and the screw rod penetrates through the side block, the extension plate and the through hole and is in screwed connection with and secured on the nut element.

Preferably, both the side blocks and the extension plates are made of metal meshes, an inner side of the first side cover and an inner side of the second side cover are fitted each other, and clamping grooves for clamping metal strips of metal meshes are concavely formed along circumferences of inner sides of the first side cover and the second side cover respectively.

Preferably, both the first side cover and the second side cover are plastic injection molding parts, and the screw rod is a metal screw rod formed and secured on the first side cover in an embedded manner.

Preferably, a plurality of the fastening assemblies are vertically spaced apart from each other.

Preferably, either of the extension plates and one corresponding side block are superimposed and horizontally arranged in a staggered manner.

Preferably, either of the extension plates has a right-angled trapezoidal structure extending horizontally.

Preferably, an area of either of the extension plates is smaller than that of either of the side blocks.

Preferably, the nut element is fixedly connected to a knob.

Preferably, the knob is a plastic injection molding part, and the nut element is formed and secured in the knob in an embedded manner.

Preferably, both the main block and the two side blocks are made of metal meshes.

Preferably, the main block has a rectangular structure extending vertically.

Preferably, the two side blocks are horizontally arranged in a symmetrical manner, and either of the side blocks has a right-angled trapezoidal structure extending vertically.

Preferably, a horizontal width of either of the side blocks is the same as that of the main block.

Preferably, the two side blocks are hinged with the left and right sides of the main block through hinges respectively.

Preferably, a plurality of the hinges are vertically spaced apart from each other.

Preferably, either of the connecting members is provided with a binding strap.

Preferably, the binding strap is an elastic strap body.

Preferably, both ends of the elastic strap body are connected to hooks.

Compared with the prior art, the present disclosure has obvious advantages and beneficial effects, and specifically, it can be seen from the above technical solution that:

The main plate assembly can be secured on the headrests of car seats through the connecting members, which separates the trunk space from the rear space, and efficiently delimits a pet activity area, thereby ensuring driving safety due to no pet disturbance to the driver, and enhancing the utilization of interior space. The present disclosure not only provides a relatively comfortable environment for both pets and passengers, but also is easily assembled and disassembled, carried and stored.

### BRIEF DESCRIPTION OF THE DRAWINGS

FIG. 1 is a three-dimensional schematic diagram of assembly according to a first preferred embodiment of the present disclosure.

FIG. 2 is an enlarged schematic diagram of a main plate assembly in the first preferred embodiment of the present disclosure.

FIG. 3 is a schematic diagram of the main plate assembly in a folded state according to the first preferred embodiment of the present disclosure.

FIG. 4 is a three-dimensional schematic diagram of assembly according to a second preferred embodiment of the present disclosure.

FIG. 5 is a three-dimensional schematic diagram of another view of assembly according to the second preferred embodiment of the present disclosure.

FIG. 6 is a three-dimensional schematic diagram of assembly of a fastening assembly according to the second preferred embodiment of the present disclosure.

FIG. 7 is a schematic diagram of a breakdown structure of the fastening assembly according to the second preferred embodiment of the present disclosure.

FIG. 8 is a schematic diagram of another view of a breakdown structure of the fastening assembly according to the second preferred embodiment of the present disclosure.

### DESCRIPTION OF REFERENCE NUMERALS

10. main plate assembly; 11. main block;

12. side block; 13. hinge;

101. metal strip; 20. connecting member;

21. elastic strap body; 22. hook;

30. fastening assembly; 31. first side cover;

32. second side cover; 33. nut element;

34. screw rod; 35. knob;

301. through hole; 302. clamping groove; and

40. extension plate.

### DETAILED DESCRIPTIONS OF THE EMBODIMENTS

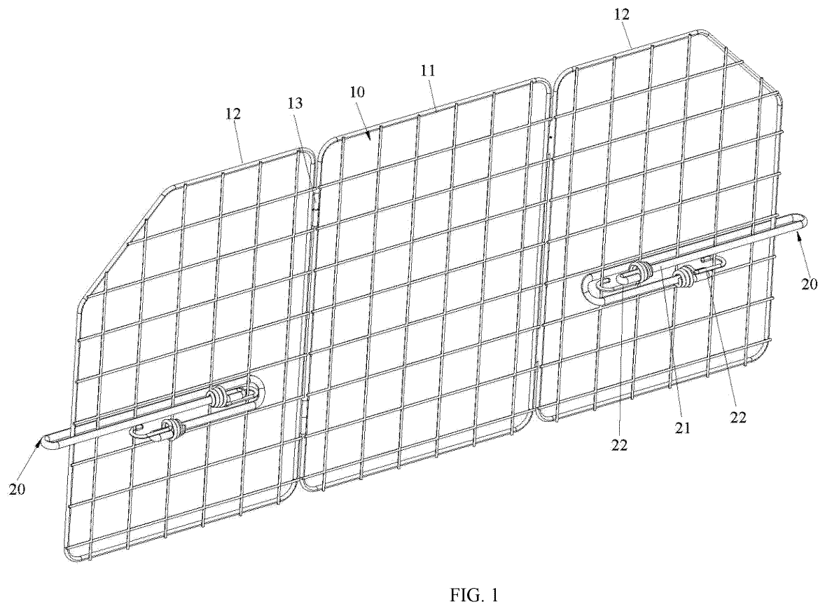

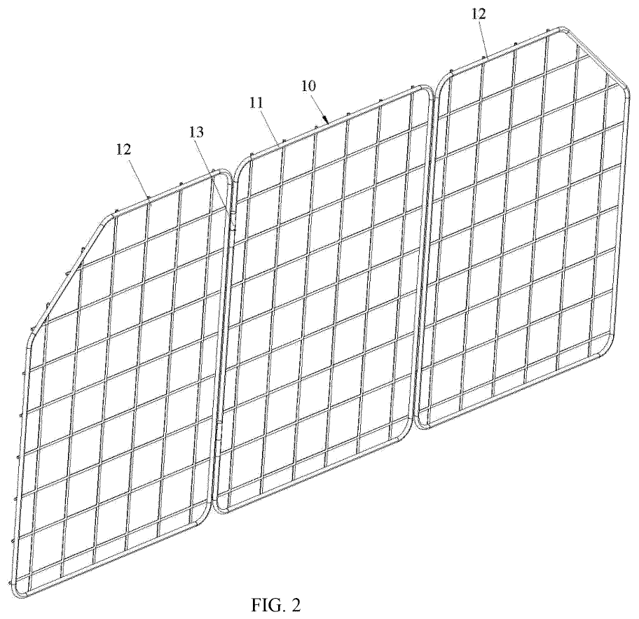

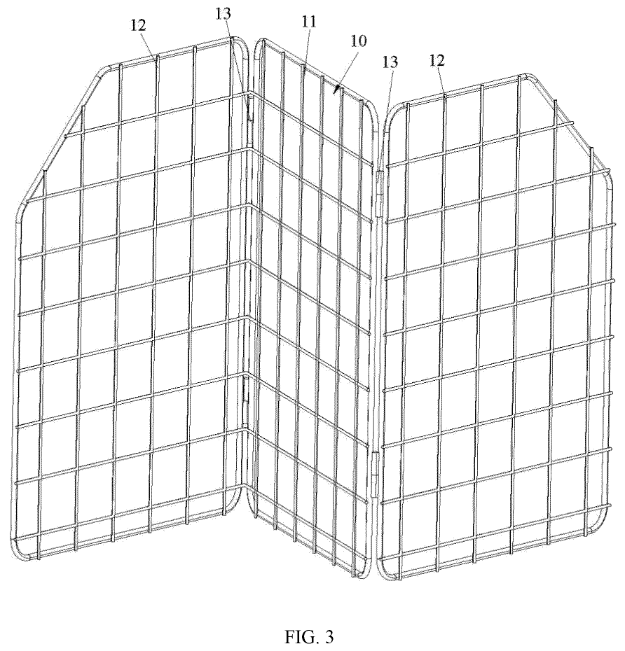

With reference to FIGS. 1-3, a specific structure of the present disclosure in a first preferred embodiment is shown, including a main plate assembly 10 and two connecting members 20 for fixedly connecting headrests of car seats.

The main plate assembly 10 includes a main block 11 and two side blocks 12, where the two side blocks 12 are hinged with left and right sides of the main block 11, and the two side blocks 12 are arranged to be foldable or expandable relative to the main block 11. In this embodiment, the main block 11 has a rectangular structure extending vertically, the two side blocks 12 are horizontally arranged in a symmetrical manner, and either of the side blocks 12 has a right-angled trapezoidal structure extending vertically. A horizontal width of either of the side blocks 12 is the same as that of the main block 11. The two side blocks 12 are hinged with the left and right sides of the main block 11 through hinges 13 respectively, and a plurality of the hinges 13 are vertically spaced apart from each other, thereby ensuring stability of connection. Further, folding directions of the two side blocks 12 are opposite, and the two side blocks 12, after being folded, are superimposed on front and rear side surfaces of the main block 11. Further, both the main block 11 and the two side blocks 12 are made of metal meshes, and the metal meshes are high-strength. To enhance convenience of use, a storage bag may be arranged on the main plate assembly 10 (not shown in the figures) to store pet snacks, toys, and the like.

The two connecting members 20 are arranged on the two side blocks 12 respectively to ensure no shaking or shifting in the driving process. In this embodiment, either of the connecting members 20 is provided with a binding strap, the binding strap is an elastic strap body 21, and both ends of the elastic strap body 21 are connected to hooks 22 for better and quicker connection with the headrests of car seats.

A use method of this embodiment is detailed below:

In use, the main plate assembly 10 is unfolded and placed behind tops of rear seats in a car, and then the connecting members 20 are fixedly connected to headrests of the car seats, such that rear space of the car is separated from trunk space, and a pet placed in the trunk will not climb into the rear space, thereby avoiding distraction of a driver due to disturbance by the pet in the driving process, so as to ensure driving safety.

After use, the connecting members 20 are disengaged from the headrests of car seats, and then the main plate assembly 10 is folded, which occupies small space, thereby facilitating storage and carrying.

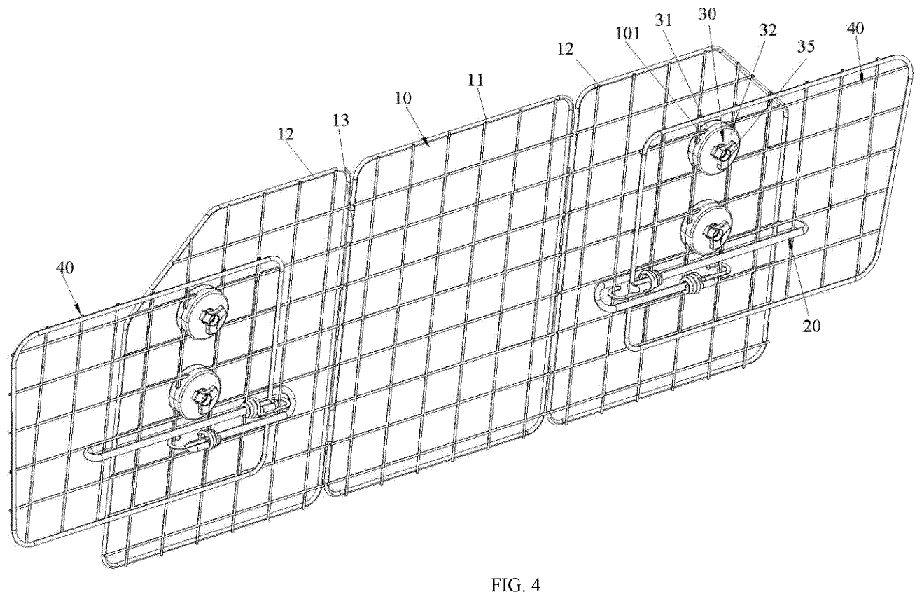

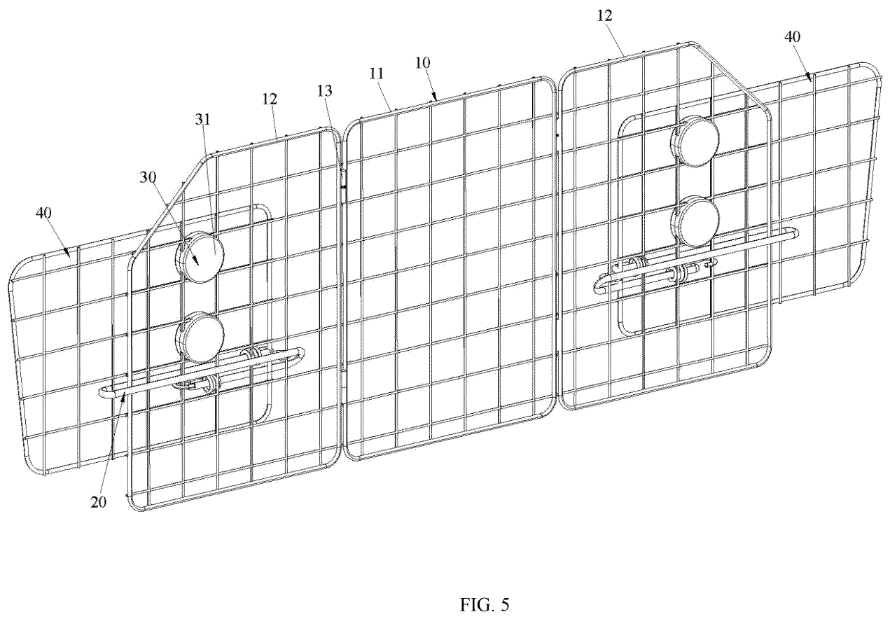

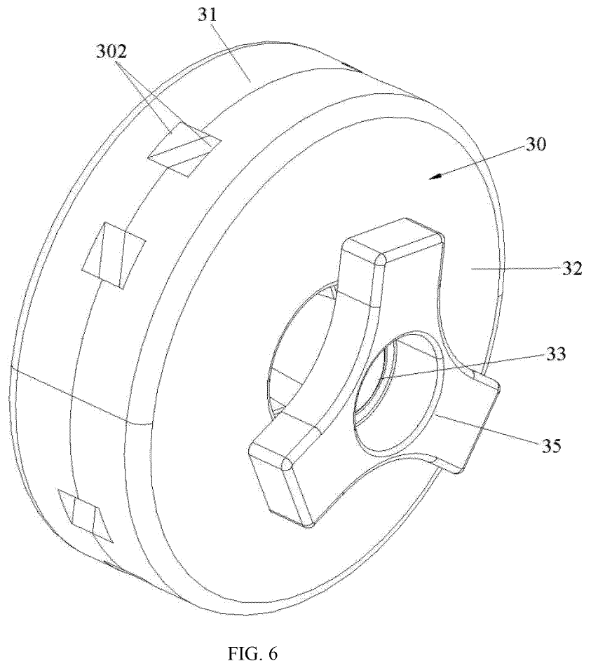

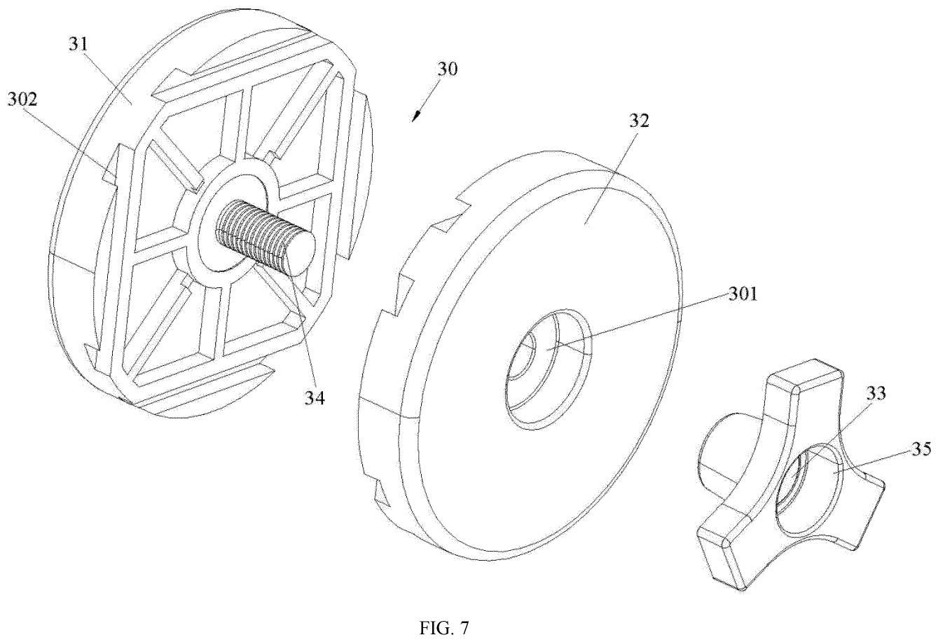

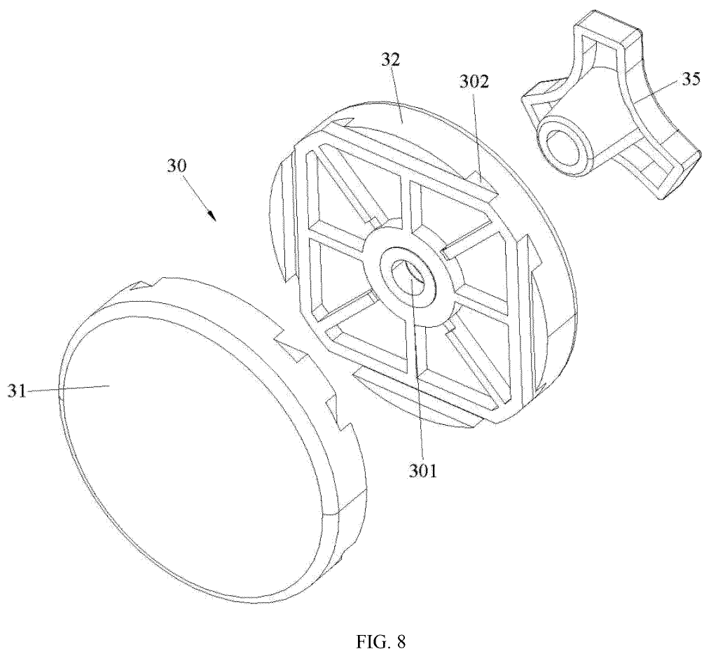

With reference to FIGS. 4-8, a specific structure of a second preferred embodiment of the present disclosure is shown. The specific structure of this embodiment is basically the same as that of the first preferred embodiment, and the differences are as follows:

In this embodiment, extension plates 40 are mounted on the two side blocks 12 through fastening assemblies 30 respectively. Details are specifically as follows:
a plurality of the fastening assemblies 30 are vertically spaced apart from each other to mount the extension plates 40 in a more secure manner. Each of the fastening assemblies 30 includes a first side cover 31, a second side cover 32 and a nut element 33, a screw rod 34 is arranged on the first side cover 31, and a through hole 301 is formed in the second side cover 32; and the side block 12 and the extension plate 40 are clamped between the first side cover 31 and the second side cover 32, and the screw rod 34 penetrates through the side block 12, the extension plate 40 and the through hole 301 and is in screwed connection with and secured on the nut element 33. In this embodiment, an inner side of the first side cover 31 and an inner side of the second side cover 32 are fitted each other, and clamping grooves 302 for clamping metal strips 101 of metal meshes are concavely formed along circumferences of inner sides of the first side cover 31 and the second side cover 32 respectively. Further, both the first side cover 31 and the second side cover 32 are plastic injection molding parts, and the screw rod 34 is a metal screw rod formed and secured on the first side cover 31 in an embedded manner. The nut element 33 is fixedly connected to a knob 35. The knob 35 is a plastic injection molding part, and the nut element 33 is formed and secured in the knob 35 in an embedded manner.

Either of the extension plates 40 and one corresponding side block 12 are superimposed and horizontally arranged in a staggered manner, to increase a horizontal width of the present disclosure and create wider interior space of the car. Further, either of the extension plates 40 has a right-angled trapezoidal structure extending horizontally. An area of either of the extension plates 40 is smaller than that of either of the side blocks 12.

A use method of this embodiment is detailed below:

Before use, a mounting position between either of the extension plates 40 and one corresponding side block 12 is adjusted based on a width of interior space of the car, then either of the extension plates 40 and the corresponding side block 12 are fixed to each other through the fastening assemblies 30, then the present disclosure is placed behind tops of rear seats in a car, and then the connecting members 20 are fixedly connected to headrests of the car seats, such that rear space of the car is separated from trunk space, and a pet placed in the trunk will not climb into the rear space, thereby avoiding distraction of a driver due to disturbance by the pet in the driving process, so as to ensure driving safety.

After use, the connecting members 20 are disengaged from the headrests of car seats, the extension plates 40 and the side blocks 12 are aligned and superimposed after the fastening assemblies 30 are disengaged, the fastening assemblies 30 are used to lock tightly after the superimposing, and then the main plate assembly 10 is folded, which occupies small space, thereby facilitating storage and carrying.

A design focus of the present disclosure is as follows: the main plate assembly can be secured on the headrests of car seats through the connecting members, which separates the trunk space from the rear space, and efficiently delimits a pet activity area, thereby ensuring driving safety due to no pet disturbance to the driver, and enhancing the utilization of interior space. The present disclosure not only provides a relatively comfortable environment for both pets and passengers, but also is easily assembled and disassembled, carried and stored.

Technical principles of the present disclosure are described above with reference to specific embodiments. These descriptions are only intended to explain the principles of the present disclosure and cannot be interpreted, in any way, as limiting the protection scope of the present disclosure. Based on the explanation, other specific embodiments of the present disclosure can be contemplated by those skilled in the art without making creative efforts, and all these embodiments fall within the protection scope of the present disclosure.

What is claimed is:

1. A pet screen, comprising a main plate assembly and two connecting members for fixedly connecting headrests of car seats, wherein the main plate assembly comprises a main block and two side blocks, wherein the two side blocks are hinged with left and right sides of the main block, and the two side blocks are arranged to be foldable or expandable relative to the main block; and the two connecting members are arranged on the two side blocks respectively.

2. The pet screen according to claim 1, wherein extension plates are mounted on the two side blocks through fastening assemblies respectively.

3. The pet screen according to claim 2, wherein each of the fastening assemblies comprises a first side cover, a second side cover and a nut element, a screw rod is arranged on the first side cover, and a through hole is formed in the second side cover; and the side block and the extension plate are clamped between the first side cover and the second side cover, and the screw rod penetrates through the side block, the extension plate and the through hole and is in screwed connection with and secured on the nut element.

4. The pet screen according to claim 3, wherein both the side blocks and the extension plates are made of metal meshes, an inner side of the first side cover and an inner side of the second side cover are fitted each other, and clamping grooves for clamping metal strips of metal meshes are concavely formed along circumferences of inner sides of the first side cover and the second side cover respectively.

5. The pet screen according to claim 3, wherein both the first side cover and the second side cover are plastic injection molding parts, and the screw rod is a metal screw rod formed and secured on the first side cover in an embedded manner.

6. The pet screen according to claim 3, wherein a plurality of the fastening assemblies are vertically spaced apart from each other.

7. The pet screen according to claim 3, wherein either of the extension plates and one corresponding side block are superimposed and horizontally arranged in a staggered manner.

8. The pet screen according to claim 3, wherein either of the extension plates has a right-angled trapezoidal structure extending horizontally.

9. The pet screen according to claim 3, wherein an area of either of the extension plates is smaller than that of either of the side blocks.

10. The pet screen according to claim 3, wherein the nut element is fixedly connected to a knob.

11. The pet screen according to claim 10, wherein the knob is a plastic injection molding part, and the nut element is formed and secured in the knob in an embedded manner.

12. The pet screen according to claim 1, wherein both the main block and the two side blocks are made of metal meshes.

13. The pet screen according to claim 1, wherein the main block has a rectangular structure extending vertically.

14. The pet screen according to claim 1, wherein the two side blocks are horizontally arranged in a symmetrical manner, and either of the side blocks has a right-angled trapezoidal structure extending vertically.

15. The pet screen according to claim 1, wherein a horizontal width of either of the side blocks is the same as that of the main block.

16. The pet screen according to claim 1, wherein the two side blocks are hinged with the left and right sides of the main block through hinges respectively.

17. The pet screen according to claim 16, wherein a plurality of the hinges are vertically spaced apart from each other.

18. The pet screen according to claim 1, wherein either of the connecting members is provided with a binding strap.

19. The pet screen according to claim 18, wherein the binding strap is an elastic strap body.

20. The pet screen according to claim 19, wherein both ends of the elastic strap body are connected to hooks.
